(19) United States
(12) Patent Application Publication
(10) Pub. No.: US 2017/0219143 A1
(43) Pub. Date: Aug. 3, 2017

(54) FLUID DIVERTER DEVICE

(71) Applicant: Henry F. De Francesco, Pompano Beach, FL (US)

(72) Inventor: Henry F. De Francesco, Pompano Beach, FL (US)

(21) Appl. No.: 15/390,612

(22) Filed: Dec. 26, 2016

Related U.S. Application Data
(60) Provisional application No. 62/289,194, filed on Jan. 30, 2016.

(51) Int. Cl. F16L 27/00

(52) U.S. Cl. CPC F16L 27/00

(57) ABSTRACT

In some embodiments, a fluid diverter device may include a diverter body having a body surface coupled to a first end and to an opposing a second end. A diverter conduit may be centrally positioned within the diverter body, and the conduit may extend between the first end and second end. A coupler plug may be disposed on the second end, and an accessory socket may be disposed on the first end. The coupler plug may have c coupler conduit in fluid communication with the diverter conduit. The device may further comprise a bend which may be formed in the diverter body, and the bend may be configured to angle the first end towards the second end. In further embodiments, the bend may comprise a bend angle, and the bend angle may be between 35 degrees and 49 degrees and more preferably between 40 and 44 degrees.

### CROSS REFERENCE TO RELATED APPLICATIONS

This application claims priority to and the benefit of the filing date of U.S. Provisional Application No. 62/289,194, filed on Jan. 30, 2016, entitled “WATER PRESSURE DELIVERY SYSTEM”, which is hereby incorporated by reference in its entirety.

### FIELD OF THE INVENTION

This patent specification relates to the field of fluid diverting devices. More specifically, this patent specification relates to a fluid diverting device which may be used to connect a fluid supply to a fluid delivery accessory and divert fluid from the fluid supply while maintaining the alignment or orientation between the fluid supply and fluid delivery accessory.

### BACKGROUND

Fluid coupling devices are commonly used to connect a fluid supply to a fluid delivery accessory in which the fluid supply provides a fluid, such as water, and other liquids, air, and other gasses, a fluid delivery accessory. Fluid supplies may include pressure washers, water pumps, other liquid pumps, hoses, conduits, air tanks, air compressors, gas lines, and the like. Fluid delivery accessories may include spray guns, spray nozzles, spray wands, gutter cleaning spraying attachments, air nozzles, air guns, and the like. For example, a fluid coupling device may connect a pressure washer, with its gas engine or electric motor driven water pump, to a gun, wand and nipple or spray assembly, in order to use the water to perform various functions.

Many fluid coupling devices exist which are configured to connect a fluid supply to a fluid delivery accessory while allowing the alignment or orientation of the fluid delivery accessory relative to the fluid supply to be changed. These fluid coupling devices most commonly provide a rotational coupling to that the fluid delivery accessory can be rotated relative to the fluid supply so that the fluid delivery accessory can be more easily moved according to user preference. While a rotational coupling may facilitate the use of some fluid delivery accessories, it can make other fluid delivery accessories more difficult to use since the orientation between the fluid delivery accessory and the fluid supply can be easily changed. For example, using a pressure washer fluid supply that is coupled to an elongated gutter cleaning fluid delivery accessory via a rotational coupling may be difficult since the orientation of the gutter cleaning accessory may be changed during movement or from hitting an object requiring the user to pause and re-orient the gutter cleaning accessory.

While some fluid coupling devices seek to maintain the alignment or orientation between a fluid delivery accessory and a fluid supply, they suffer from many drawbacks. For example, U.S. patent application Ser. No. 14/521,244 by Johnson describes a pressure washer coupler provided between the wand and spray nozzle of a pressure washer so that the angle of the spray can be selectively set. While different embodiments can preset the direction of flow at 30, 45 and 60 degree increments from the original direction, the pressure washer coupler is very complex and costly to produce. Additionally, because of the pressure washer coupler's off center line mass, it is easy to turn out of the desired orientation due to the virtually friction free socket. For this reason, the pressure washer coupler, like many other coupling devices, will lose its direction when moving or hitting an object.

Human anatomy dictates that a typical user of a pressure washer normally aims the gun and wand at an angle of approximately 48 degrees to a horizontal surface. Laws of Physics dictate that a force F applied at an angle will split into two components at right angles to each other. At 48 degrees, one component is 0.75 with the force at 0.56.3F. The other component is 0.66 with the force at 0.437F. At 45 degrees, the two components are equal at 0.707 with the forces at 0.5F. Differences in the force components of the water pressure at the surface become apparent to an operator when the operator changes the orientation of the gun and wand to an angle more vertical to the surface. However, maintaining the orientation of the gun and wand vertical to the surface can be physically stressful for the operator. For this reason, there exists a need for a device that directs the water pressure stream more vertical to the surface, and thereby be more effective in cleaning or preparing the surface.

Typically, the operator of a pressure washer applies water pressure to the surface at an average angle of 48 degrees which applies water to a horizontal surface at a less than ideal angle. To direct the stream vertical to the surface, there exists a need for an apparatus that redirects water flow at an angle 42 degrees from the direction of the gun-wand assembly. Diverting the direction of the water flow 42 degrees from the direction of the gun-wand assembly results in a significant increase in water pressure at the surface, thereby increasing cleaning power, reducing cleaning time, use of water and energy. Lowering the gun-wand assembly a few degrees produces sufficient forward water pressure power to wash away the removed sediment from the surface.

Attempts were made to use a commercially available pivot attachment to redirect the water stream vertical to the surface. However, when the pivot attachment was used for this purpose, there was a significant decrease in water pressure at its outlet. Also noted, quick movements or contact with a surface caused the pivot attachment, or gutter cleaner accessory, to rotate in their sockets and thus change the direction of the spray. This failing indicated a need for a device that fixed the orientation of these accessories in their socket. This experience also indicated a need for a device that fixed the orientation of the accessory while directing the water stream in the selected direction.

Therefore a need exists for novel fluid diverting devices capable of diverting the direction of the water flow provided by a pressure washer type fluid supply between 40 and 45 degrees from the direction of a gun-wand assembly to provide a significant increase in water pressure at the surface, thereby increasing cleaning power, reducing cleaning time, use of water and energy compared to existing fluid dispensing apparatuses which are currently used with pressure washers. A further need exists for a novel fluid diverter device which is able to perform all of the functions of the coupler described in U.S. patent application Ser. No. 14/521,244 by Johnson without any of the short comings of that coupler which include: the inability to prevent the orientation of the coupler or a device attached thereto from having its orientation changed and thus change the direction of the spray through inadvertent contact with a surface or other actions typically encountered during use; and the limited ability to fix the orientation of an accessory while directing the water stream in a limited number of selected directions. . Finally, a need exists for novel fluid diverting devices which may be used to connect a fluid supply to a fluid delivery accessory while selectively maintaining the alignment or orientation between the fluid supply and fluid delivery accessory.

### BRIEF SUMMARY OF THE INVENTION

A fluid diverter device is provided that selects and fixes the direction of the water stream from a fluid supply type water pressure delivery system. With this device coupled to a water pressure delivery system, the water pressure delivery system becomes especially adaptable to usages where water pressure has to be applied to surfaces not readily accessible. Moreover, the manner in which the direction of the water stream is selected and fixed ensures that the direction, once set, cannot be changed through contact or rapid motion. Additionally, the device can be used with any currently available water pressure delivery system and its assorted attachments. Further, the connector plug of existing water pressure systems can be retrofitted with the modified plugs of the disclosed fluid diverter device.

The disclosed fluid diverter device when used with a water pressure delivery system is able to divert and direct fluid with a significant increase in water pressure at its outlet. Additionally, the fluid diverter device is able to prevent the orientation of the coupler plug or a device attached thereto from having its orientation, changed by inadvertent contact with a surface or other actions typically encountered during use. Furthermore, the fluid diverter device provides an enhanced ability to fix the orientation of an accessory while directing the water stream in a preferably eight or more directions.

In some embodiments, the fluid diverter device may include a diverter body having a body surface which may be coupled to a first end and to an opposing a second end. A conduit for conducting a fluid may be centrally positioned within the diverter body, and the conduit may extend between the first end and second end. A coupler plug may be disposed on the second end, and an accessory socket may be disposed on the first end. The device may further comprise a bend which may be formed in the diverter body, and the bend may be configured to angle the first end towards the second end.

In further embodiments, the bend may have a bend angle, and the bend angle may be between 35 degrees and 49 degrees and more preferably between 40 and 44 degrees.

In still further embodiments, the fluid diverter device may include a coupler plug which includes changes to the design and manufacture of the standard quick connection plug. The coupler plug of the fluid diverter device may have one or more, such as eight, spherical peripheral indents around the circumference of the body of the coupler plug. The one or more peripheral indents may be shaped and spaced to match the spacing of the balls of a quick connection female coupling device when the coupler plug is inserted into the female coupling device. Preferably, the coupler plug with its peripheral indents, when inserted in the female coupling device, may be mechanically held in place and may not be easily rotated in the socket of the female coupling device. However, in some embodiments, the fluid diverter device may use the plug of a commercially available snap type quick connection instead of the coupler plug.

In some embodiments, a coupler plug is provided which may be used with or without a fluid diverter device. The coupler plug may include a coupler body having a coupler surface coupled to a coupler joining end and to an opposing a coupler terminus. A coupler conduit may be centrally positioned within the coupler body extending between the coupler joining end and coupler terminus. The coupler plug may further include one or more peripheral indents which may form a depression in the coupler surface, in which one or more of the peripheral indents has a width of between 2.5 millimeters and 3.5 millimeters.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a side perspective view of an example of a fluid diverter device according to various embodiments described herein.

FIG. 2 illustrates a side perspective view of an example of a fluid diverter device according to various embodiments described herein.

FIG. 3 shows a side perspective view of an example of a coupler plug of a fluid diverter device according to various embodiments described herein.

FIG. 4 depicts a perspective view of an example of a coupler plug of a fluid diverter device according to various embodiments described herein.

FIG. 5 illustrates a sectional, through line 5-5 shown in FIG. 3, elevation view of an example of a coupler plug of a fluid diverter device according to various embodiments described herein.

FIG. 6 shows a top perspective view of an example of a female coupling device according to various embodiments described herein.

FIG. 7 depicts a side perspective view of a further example of a coupler plug of a fluid diverter device according to various embodiments described herein.

FIG. 8 illustrates a sectional, through line 8-8 shown in FIG. 7, elevation view of an example of a coupler plug of a fluid diverter device according to various embodiments described herein.

FIG. 9 shows a side perspective view of still a further example of a coupler plug of a fluid diverter device according to various embodiments described herein.

FIG. 10 depicts a sectional, through line 10-10 shown in FIG. 9, elevation view of an example of a coupler plug of a fluid diverter device according to various embodiments described herein.

FIG. 11 illustrates a perspective view of a further example of a coupler plug which may be used with a fluid diverter device according to various embodiments described herein.

FIG. 12 shows a side perspective view of a still further example of a coupler plug which may be used with a fluid diverter device according to various embodiments described herein.

FIG. 13 depicts a perspective view of a user utilizing a prior art pressure washer.

FIG. 14 illustrates a perspective view of a user utilizing a pressure washer with an example of the fluid diverter device according to various embodiments described herein.

FIG. 15 shows a partial sectional, through line 15-15 shown in FIG. 1, elevation view of an example of a coupler plug manufactured into the diverter body of a fluid diverter device according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

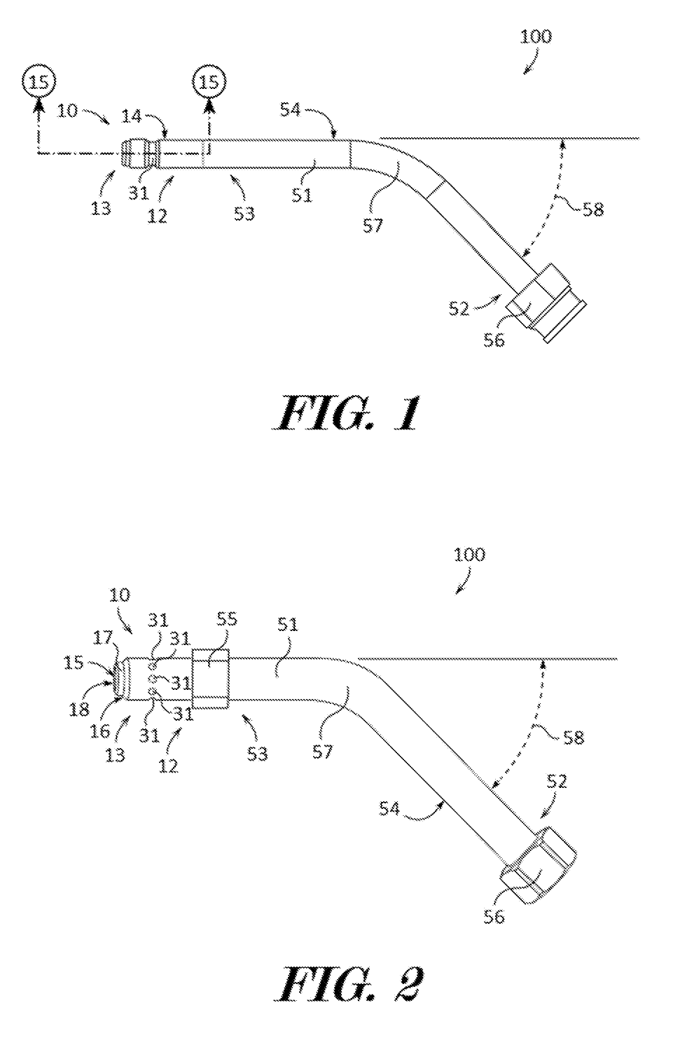

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

New fluid diverting devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

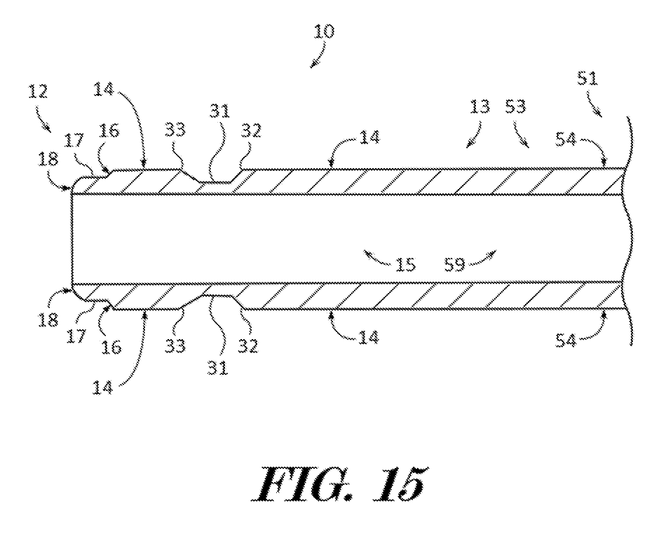

The present invention will now be described by example and through referencing the appended figures representing preferred and alternative embodiments. FIGS. 1-3 illustrate an example of an alignment coupling device (“the device”) 100 according to various embodiments. In this example, the device 100 comprises a diverter body 51 having a body surface 54 which may be coupled to a first end 52 and to an opposing a second end 53. A diverter conduit 59 (FIG. 15) for conducting a fluid 300 may be centrally positioned within the diverter body 51, and the diverter conduit 59 may extend between the first end 52 and second end 53. A coupler plug 10 having a coupler body 11, a coupler joining end 12, and a coupler terminus 13 may be disposed on the second end 53, and an accessory socket 56 may be disposed on the first end 52. The coupler plug 10 may comprise a coupler conduit 15 centrally positioned within the coupler body 11 in which the coupler conduit 15 may extend between the coupler joining end 12 and coupler terminus 13 with the coupler conduit 15 in fluid communication with the diverter conduit 59 as shown in FIG. 15. The device 100 may further comprise a bend 57 which may be formed in the diverter body 51, and the bend 57 may be configured to angle the first end 52 towards the second end 53.

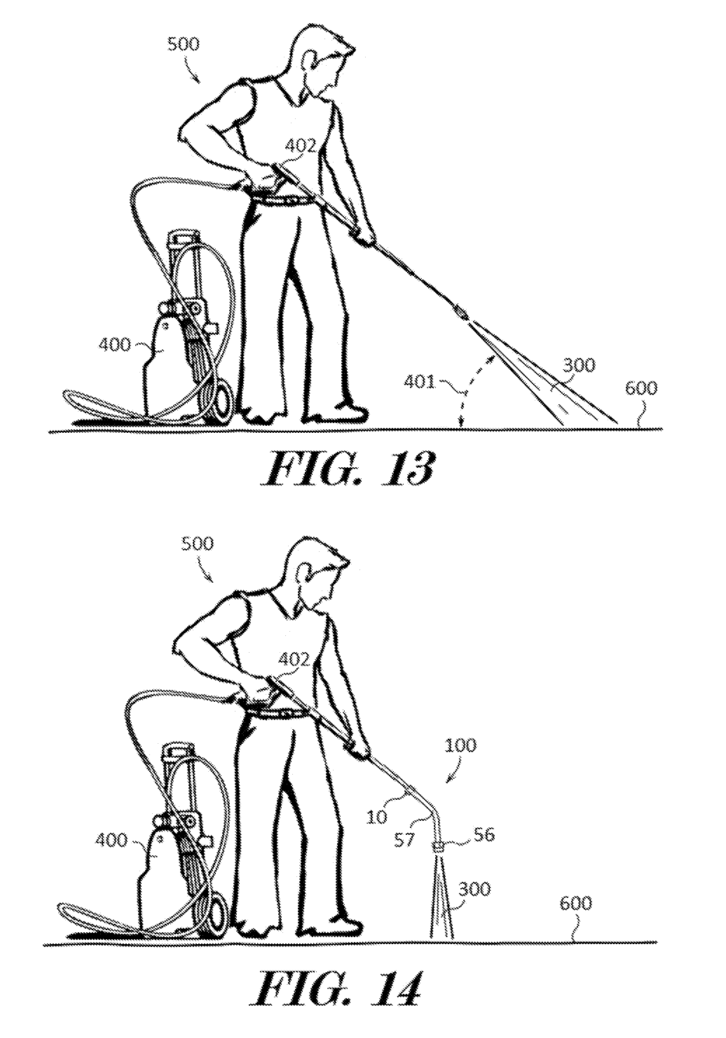

Optionally, the diverter body 51 may be of any desired length and may be bent so as to change the direction of travel of a fluid 300 passing through the device 100. As shown in the example of a user utilizing a prior art pressure washer 400 depicted in FIG. 13, typical pressure washing apparatuses direct a fluid 300, such as water, at an average angle 401 of 48 degrees which applies the fluid 300 to a horizontal surface 600 at a less than ideal angle. As contrasted to the example of a user 500 utilizing a pressure washer 400 with an example of the fluid diverter device 100 shown in FIG. 14, the device 100 directs the stream vertical to the horizontal surface 600, resulting in a significant increase in fluid 300 pressure at the surface 600, thereby increasing cleaning power, reducing cleaning time, use of water and energy.

As perhaps best shown by the example fluid diverter devices 100 illustrated in FIGS. 1 and 2, the device 100 may comprise a bend 57 formed in the diverter body 51. The bend 57 may angle the first end 52, and therefore an optional accessory socket 56 coupled thereto, towards the second end 53, and therefore towards a coupler plug 10 coupled thereto. The bend 57 may comprise a bend angle 58. In some embodiments, the bend angle 58 may be between 35 degrees and 49 degrees. In preferred embodiments, the bend angle 58 may be between 40 degrees and 44 degrees. In further preferred embodiments, the bend angle 58 may redirect fluid 300 that travels through the conduit 15 of the device 100 at an angle 42 degrees from the direction of the gun-wand assembly 402 of a pressure washer 400.

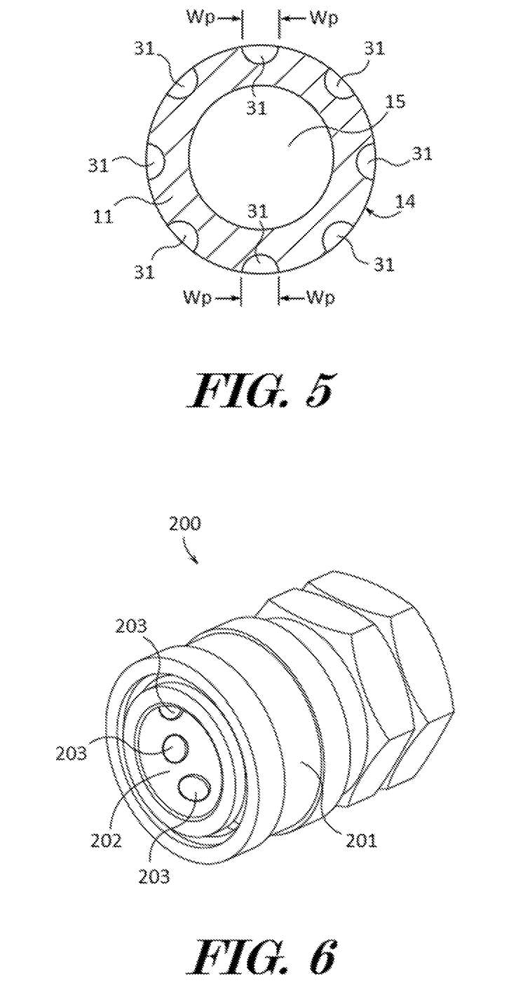

In some embodiments, the device 100 may comprise a coupler plug 10 which may be used to mate with a female coupling device 200 (FIG. 6). A coupler plug 10 may comprise a coupler body 11 having a coupler joining end 12 and an opposing coupler terminus 13 with a coupler surface 14 extending between the coupler joining end 12 and coupler terminus 13. The coupler conduit 15 may be centrally positioned within the coupler body 11 and may extend between the coupler joining end 12 and coupler terminus 13. One or more peripheral indents 31 each comprising a first peripheral terminus 32 may also be disposed on the coupler body 11 with each peripheral indent 31 forming a depression in the coupler surface 14. Preferably, the first peripheral terminus 32 of the one or more peripheral indents 31 may be the same distance from the coupler joining end 12. Optionally, one or more elements of the device 100 may be made from brass, stainless steel, other metal alloys, hard plastics, or any other suitable material.

In some embodiments and as depicted in FIGS. 1, 2, and 14, the device 100 may comprise an accessory socket 56 which may be coupled to the coupler joining end 12. An accessory socket 56 may be configured to direct a fluid passing exiting the device 100. For example, an accessory socket 56 may accept different spray pattern nozzles or be configured to be coupled to other fluid dispensing accessories such as spray guns, extension wands, gutter cleaning wands, or the like.

In some embodiments, the device 100 may comprise an optional fitting 55 (FIGS. 1-4, 7, 9, and 11) which may be coupled or formed with the coupler plug 10 and/or diverter body 51. A fitting 55 may be configured with any size or shape and may facilitate the ability of a user to connect or mate the coupler plug 10 with a female coupling device 200 or any other object.

Now also referring to FIG. 6, in some embodiments, the coupler plug 10 of the device 100 may be mated with a female coupling device 200. A female coupling device 200 may have a female body 201 which forms and bounds a female conduit 202. One, two, three, four, five, six, seven, eight, nine, ten or more ball detents 203 may be movably coupled to the female body 201. The ball detents 203 which may have a width of between 2 millimeters and 5 millimeters, and preferably a width of between 2.5 millimeters and 3.5 millimeters, may be under tension, such as from a spring, and be configured to move away from the center of the female conduit 202 when compressed and towards the center of the female conduit 202 when not compressed. Typically, the ball detents 203 may be positioned within the female conduit 202 so that the ball detents 203 are approximately equidistant from each other and equidistant from the ends of the female conduit 202. An exemplary female coupling device 200 may have eight ball detents 203 radially positioned at increments of forty five degrees within the female conduit 202.

In some embodiments, when the coupler plug 10 of the device 100 is mated to the female coupling device 200, one or more ball detents 203 may enter or be received in one or more peripheral indents 31 thereby engaging or mating the device 100 to the female coupling device 200. In other embodiments, one or more ball detents 203 may enter or be received in one or more peripheral indents 31 thereby engaging or mating the device 100 to the female coupling device 200. In still further embodiments, each ball detent 203 may enter or be received in a peripheral indent 31.

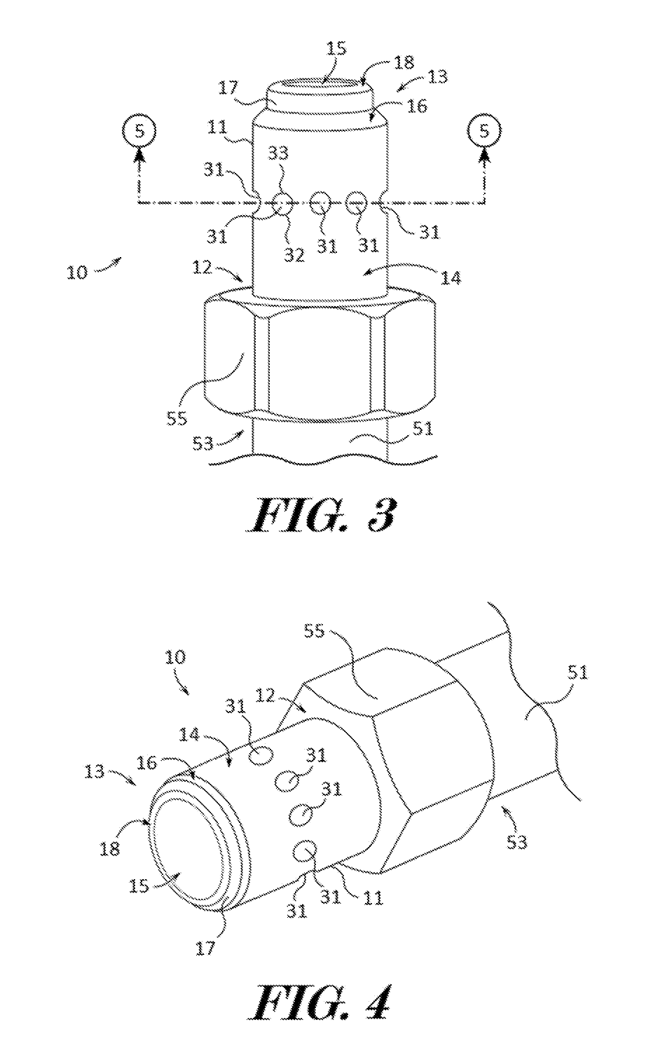

The coupler plug 10 of the device 100 may comprise one or more peripheral indents 31. Generally, a peripheral indent 31 may form a depression in the coupler surface 14 into which one or more ball detents 203 may be received. A peripheral indent 31 may comprise a first peripheral terminus 32 and a second peripheral terminus 33 as shown in FIGS. 3, 7, and 9). The first peripheral terminus 32 may form the portion of the peripheral indent 31 that is closest to the coupler joining end 12. The second aligning terminus 23 may form the portion of the peripheral indent 31 that is closest to the coupler terminus 13. In some embodiments, the first peripheral terminus 32 and the second peripheral terminus 33 may be separated from each other by a distance that is approximately equal to the width of a ball detent 203, such as between 2 millimeters and 5 millimeters, and preferably between 2.5 millimeters and 3.5 millimeters, so that the ball detent 203 received in the peripheral indent 31 may not be moved towards or away from the first peripheral terminus 32 and the second peripheral terminus 33 while received in the peripheral indent 31. In this manner the engagement between a peripheral indent 31 and a ball detent 203 received therein may maintain the distance between a device 100 mated to a female coupling device 200.

As shown in FIGS. 5 and 8, a peripheral indent 31 may comprise a peripheral width (Wp). In some embodiments, Wp may be approximately equal to the width of a ball detent 203, such as between 2 millimeters and 5 millimeters, and preferably between 2.5 millimeters and 3.5 millimeters, so that a ball detent 203 received within the peripheral indent 31 may be prevented from moving side to side thereby maintaining the orientation or alignment between the device 100 and the female coupling device 200 so that they may not rotate relative to each other. In other embodiments, Wp may be greater than the width of a ball detent 203 so that two or more ball detents 203 may be received within the peripheral indent 31.

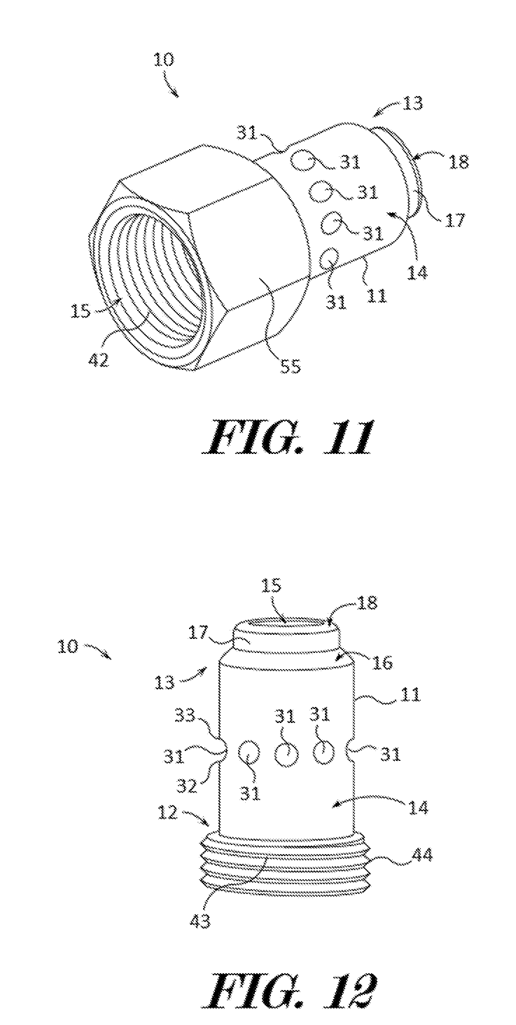

Each peripheral indent 31 may be shaped to receive one or more ball detents 203 (FIG. 11). In some embodiments, a peripheral indent 31 may be spherical in shape as illustrated in FIGS. 2-5, 11, and 12. In other embodiments, a peripheral indent 31 may comprise a generally angular shape as shown in FIGS. 1, 7-10. In still further embodiments, the coupler plug 10 of the device 100 comprises a single peripheral indent 31 that is continuous and extends around the coupler surface 14, such as a male M22 style quick connector or coupler, as perhaps best illustrated in FIG. 1.

It should be understood to one of ordinary skill in the art that a peripheral indent 31, and any other element or surface discussed herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Turning now to the example of FIGS. 1-3, 7, and 8, in some embodiments, the device 100 may comprise a coupler plug 10 configured to mate with a female coupling device 200 having eight ball detents 203 and the coupler plug 10 may comprise one angular shaped peripheral indent 31 and seven peripheral indents 31. The peripheral indents 31 are shown equidistant from each other and radially positioned on the coupler surface 14. The coupler plug 10 and therefore the device 100 may be aligned or oriented in approximately forty five degree increments relative to the female coupling device 200 when the coupler plug 10 of the device 100 is mated with a female coupling device 200 so that the ball detents 203 are received in the indents 31.

In some embodiments and as shown in FIG. 5, the Wp of one or more of the peripheral indents 31 may each be approximately equal to the width of a ball detent 203, such as between 2 millimeters and 5 millimeters, and preferably between 2.5 millimeters and 3.5 millimeters, so that a ball detent 203 received within each indent 31 may be prevented from moving side to side in the indent 31 thereby maintaining the orientation or alignment between the coupler plug 10 and therefore the device 100 and the female coupling device 200 so that they may not rotate relative to each other when mated together.

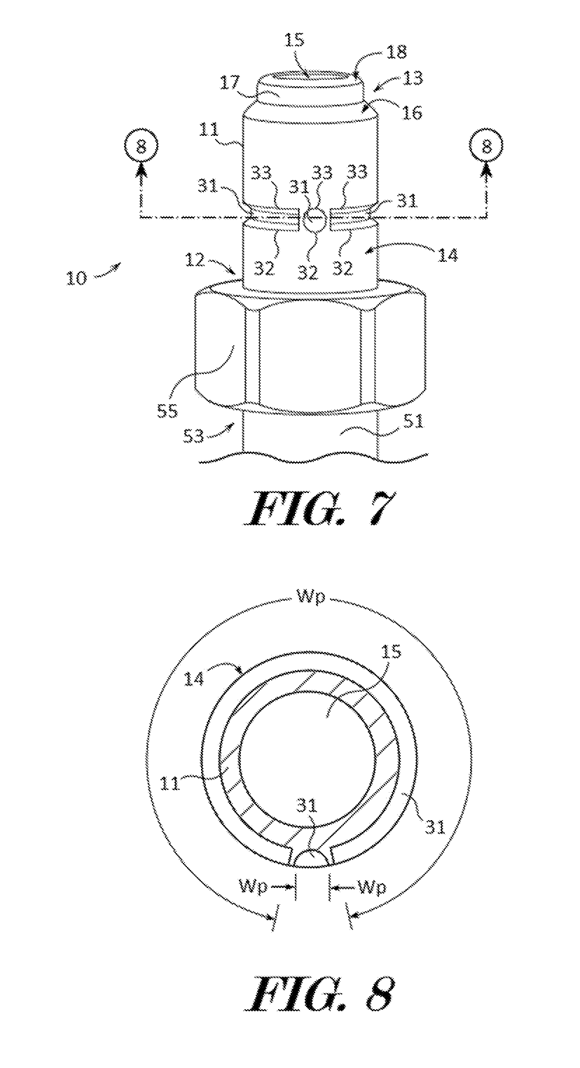

Referring to the example of FIGS. 7 and 8, in some embodiments, the coupler plug 10 of the device 100 may comprise one relatively larger peripheral indent 31 and one relatively smaller peripheral indent 31 with the relatively smaller peripheral indent 31 being configured to receive one ball detent 203 and the relatively larger peripheral indent 31 being configured to receive two or more ball detents 203. For example, the coupler plug 10 may be configured to mate with a female coupling device 200 having six ball detents 203 and the device 100 may comprise one relatively smaller peripheral indent 31 configured to receive one ball detent 203 and one relatively larger peripheral indent 31 configured to receive five detents 203. The relatively larger peripheral indent 31 and one relatively smaller peripheral indent 31 are shown positioned radially on the coupler surface 14. The coupler plug 10 and therefore the device 100 may be aligned or oriented in approximately sixty degree increments relative to the female coupling device 200 when the coupler plug 10 of the device 100 is mated with a female coupling device 200 so that the ball detents 203 are received in the indents 31.

The Wp of the relatively larger peripheral indent 31 may be greater than the width of a ball detent 203 so that two or more ball detents 203 may be received within the peripheral indent 31 when the coupler plug 10 of the device 100 and the female coupling device 200 are mated or engaged together. The Wp of the relatively smaller peripheral indent 31 may be approximately equal to the width of a ball detent 203 so that a ball detent 203 received within the relatively smaller peripheral indent 31 may be prevented from moving side to side in the indent 31 thereby maintaining the orientation or alignment between the coupler plug 10 of the device 100 and the female coupling device 200 so that they may not rotate relative to each other when mated together.

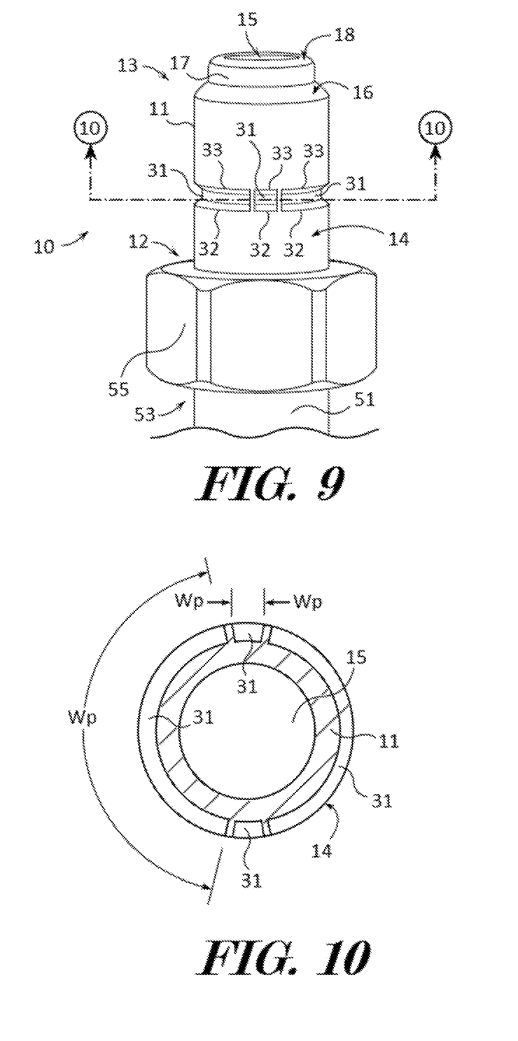

Turning now to the example of FIGS. 9 and 10, in some embodiments, the coupler plug 10 of the device 100 may comprise two relatively larger angular shaped peripheral indents 31 and two relatively smaller angular shaped peripheral indents 31 with the smaller angular indents 31 being configured to receive one ball detent 203 and the larger peripheral indents 31 being configured to receive two or more ball detents 203. For example, the coupler plug 10 of the device 100 may be configured to mate with a female coupling device 200 having ten ball detents 203 and the device 100 may comprise two relatively smaller angular shaped peripheral indents 31 configured to each receive one ball detent 203 and two relatively larger peripheral indents 31 each configured to receive four detents 203. The larger and smaller peripheral indents 31 are shown radially positioned on the coupler surface 14. The coupler plug 10 and therefore the device 100 may be aligned or oriented in approximately thirty six degree increments relative to the female coupling device 200 when the coupler plug 10 is mated with a female coupling device 200 so that the ball detents 203 are received in the indents 31.

The Wp of the relatively larger peripheral indents 31 may be greater than the width of a ball detent 203 so that two or more ball detents 203 may be received within a larger peripheral indent 31 when the coupler plug 10 of the device 100 and the female coupling device 200 are mated or engaged together. The Wp of the relatively smaller angular indents may be approximately equal to the width of a ball detent 203 so that a ball detent 203 received within the smaller indents 31 may be prevented from moving side to side in the indents 31 thereby maintaining the orientation or alignment between the coupler plug 10 of the device 100 and the female coupling device 200 so that they may not rotate relative to each other when mated together. In this manner, a coupler plug 10 may comprise a relatively smaller first peripheral indent 31 having a width that is between 2.5 millimeters and 3.5 millimeters and a relatively larger second peripheral indent 31 which comprises a width that is greater than the width of the first peripheral indent 31.

As shown in FIGS. 2-4, 7, 9, and 12, in some embodiments, the coupler plug 10 of the device 100 may comprise a mating surface 16, a body extension 17, and/or an annular surface 18 which may be used to form a fluid tight seal when the coupler plug 10 is mated to a female coupling device 200 (FIG. 11) by contacting portions of the female coupling device 200.

In some embodiments, a mating surface 16 may be coupled to the coupler surface 14 and be annular in shape. Optionally, the mating surface 16 may be angled relative to the coupler surface 14 to couple a body extension 17 having a smaller diameter than the mating surface 16. In further embodiments, an annular shaped body extension 17 may extend away from the mating surface 16 and form an annular surface 18. In further embodiments, the mating surface 16, body extension 17, and/or annular surface 18 may contact a gasket within a female coupling device 200 to form a fluid tight seal when the device 100 is mated to a female coupling device 200.

Also shown in FIG. 11, in some embodiments, the coupler plug 10 of the device 100 may comprise a female threaded connector 41 which may be coupled to the coupler joining end 12 and which may be optionally used to couple the coupler plug 10 to the second end 53 of the diverter body 51. A female threaded connector 41 may comprise female threading 42 which may be configured to engage with male threading thereby allowing the device 100 to be threadedly engaged to objects having male threading.

In alternative embodiments and as illustrated in FIG. 12, the coupler plug 10 of the device 100 may comprise a male threaded connector 43 which may be coupled to the coupler joining end 12 and which may be optionally used to couple the coupler plug 10 to the second end 53 of the diverter body 51. A male threaded connector 43 may comprise male threading 44 which may be configured to engage with female threading thereby allowing the device 100 to be threadedly engaged to objects having female threading.

FIG. 15 shows a partial sectional, through line 15-15 shown in FIG. 1, elevation view of an example of a coupler plug 10 manufactured into the diverter body 51 of a fluid diverter device 100 according to various embodiments described herein In some embodiments, the coupler plug 10 may be coupled to the second end 53 of the diverter body 51 by being integrally formed, molded, or machined into the second end 53 of the diverter body. In some embodiments, the diverter body 51 and the coupler body 11 may be integrally formed by a length of tubing with the body surface 54, coupler surface 14, and one or more peripheral indents 31 formed into the length of tubing. For example, a coupler plug 10 comprising one or more peripheral indents 31 which may be machined into the second end 53 of the diverter body 51. A length of an appropriate pressure rated length of tubing having an outer diameter equal to that of a standard plug, such as an M22 type connector, may be used to form a diverter body 51 of a desired length. One end of the tubing may have one or more peripheral indents 31, drilled, punched, lathed, or otherwise formed into the tubing so that the diverter body 51 is continuous with the coupler body 11 and therefore portions of the coupler surface 14 may likewise be continuous with portions of the body surface 54. The tubing of the diverter body 51 may be bent to form the bend 57 (FIGS. 1, 2, and 14) and an accessory socket 56 (FIGS. 1, 2, and 14) may be coupled to the first end 52 (FIGS. 1, 2, and 14). In alternative embodiments, a coupler plug 10 may be heat welded, chemically welded, adhesively bonded, mechanically coupled, press fit, or otherwise coupled to the diverter body 51.

While some materials have been provided, in other embodiments, the elements that comprise the device 100 such as the coupler body 11, coupler surface 14, a peripheral indent 31, optional mating surface 16, optional body extension 17, optional annular surface 18, optional female threaded connector 41, optional male threaded connector 43, optional fluid dispensing accessory 51, and/or any other element or surface discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed:

1. A fluid diverter device, the device comprising:
A diverter body having a body surface coupled to a first end and to an opposing a second end;
A diverter conduit centrally positioned within the diverter body extending between the first end and second end;
a coupler plug disposed on the second end, wherein the coupler plug comprises a coupler body having a coupler surface coupled to a coupler joining end and coupled to an opposing a coupler terminus;
a coupler conduit centrally positioned within the coupler body, wherein the coupler conduit extends between the coupler joining end and coupler terminus, and wherein the coupler conduit is in communication with the diverter conduit;
a bend formed in the diverter body, wherein the bend angles the first end towards the second end; and
an accessory socket disposed on the first end.

2. The device of claim 1, wherein the bend comprises a bend angle, and wherein the bend angle is between 35 degrees and 49 degrees.

3. The device of claim 1, wherein the bend comprises a bend angle, and wherein the bend angle is between 40 degrees and 44 degrees.

4. The device of claim 2, wherein the coupler plug comprises a peripheral indent disposed on a coupler surface, and wherein the peripheral indent is continuous and extends around the coupler surface.

5. The device of claim 2, wherein the coupler plug comprises a first peripheral indent forming a depression in the coupler surface, and wherein the peripheral indent comprises a width that is between 2.5 millimeters and 3.5 millimeters.

6. The device of claim 5, wherein the coupler plug comprises a second peripheral indent forming a depression in the coupler surface, and wherein the peripheral indent comprises a width that is greater than the width of the first peripheral indent.

7. The device of claim 2, wherein the coupler plug comprises eight peripheral indents with each peripheral indent forming a depression in the coupler surface, and wherein each peripheral indent comprises a width that is between 2.5 millimeters and 3.5 millimeters.

8. The device of claim 7, wherein the peripheral indents are radially positioned on the coupler surface.

9. The device of claim 7, wherein the peripheral indents are equidistant from each other.

10. The device of claim 7, wherein the peripheral indents are spherical in shape.

11. The device of claim 2, wherein the diverter body and the coupler body are integrally formed together.

12. The device of claim 11, wherein the diverter body and the coupler body are integrally formed by a length of tubing, and wherein the coupler surface and a peripheral indent are formed into the length of tubing.

13. The device of claim 11, wherein the coupler plug comprises a first peripheral indent forming a depression in the coupler surface, and wherein the peripheral indent comprises a width that is between 2.5 millimeters and 3.5 millimeters.

14. The device of claim 13, wherein the coupler plug comprises a second peripheral indent forming a depression in the coupler surface, and wherein the peripheral indent comprises a width that is greater than the width of the first peripheral indent.

15. The device of claim 11, wherein the coupler plug comprises eight peripheral indents with each peripheral indent forming a depression in the coupler surface, and wherein each peripheral indent comprises a width that is between 2.5 millimeters and 3.5 millimeters.

16. The device of claim 15, wherein the peripheral indents are radially positioned on the coupler surface.

17. A coupler plug, the coupler plug comprising:
a coupler body having a coupler surface coupled to a coupler joining end and to an opposing a coupler terminus;
a coupler conduit centrally positioned within the coupler body extending between the coupler joining end and coupler terminus;
a first peripheral indent forming a depression in the coupler surface, wherein the peripheral indent comprises a width that is between 2.5 millimeters and 3.5 millimeters.

18. The coupler plug of claim 17, further comprising a second peripheral indent forming a depression in the coupler surface, and wherein the second peripheral indent comprises a width that is between 2.5 millimeters and 3.5 millimeters.

19. The coupler plug of claim 17, wherein the coupler plug comprises eight peripheral indents.

20. The coupler plug of claim 17, wherein the coupler plug comprises a second peripheral indent forming a depression in the coupler surface, and wherein the peripheral indent comprises a width that is greater than the width of the first peripheral indent.
